(19) United States
(12) Patent Application Publication
(10) Pub. No.: US 2023/0334870 A1
(43) Pub. Date: Oct. 19, 2023

(54) Scene Classification Method, Apparatus and Computer Program Product

(71) Applicant: Aptiv Technologies Limited, St. Michael (BB)

(72) Inventors: Markus Schoeler, Wuppertal (DE); Mirko Meuter, Erkrath (DE)

(21) Appl. No.: 18/184,294

(22) Filed: Mar. 15, 2023

(30) Foreign Application Priority Data
Apr. 14, 2022 (GB) 2205533.9

(51) Int. Cl. G06V 20/58; G06V 20/00; G06V 10/82

(52) U.S. Cl. CPC G06V 20/58; G06V 20/35; G06V 10/82; G06V 2201/07

(57) ABSTRACT

Scene classification method and apparatus for a vehicle sensor system. Feature maps generated from sensor data provided by the vehicle sensor system are received at an input. The feature maps are processed using longitudinal and lateral feature pooling to generate longitudinal and lateral feature pool outputs. Inner products are then generated from the longitudinal and lateral feature pool outputs. The scene is then classified based on the generated inner products.

### INCORPORATION BY REFERENCE

This application claims priority to United Kingdom Patent Application No. GB2205533.9, filed Apr. 14, 2022, the disclosure of which is incorporated by reference in its entirety.

### BACKGROUND

The applicant is a pioneer in the field of radar-centric environment perception in automotive vehicles. Usually this task is tackled either by using traditional detection-based methods combined with a tracker, or by utilizing machine learning to predict object locations, estimating free-space and/or tracking objects. The environment in which the vehicle is operating has a significant bearing on the performance, such as the detection rate or false positive rate, of those algorithms. Scenes, such as parking garages or tunnels for instance, which have many reflecting surfaces in the proximity of the vehicle, significantly affect the performance of both traditional and machine-learning algorithms for radar-based perception. Furthermore, different algorithms and models may provide better performance in some scenes, and not others. As such, accurately detecting the scene the vehicle is currently in may allow system parameters, such as settings and behaviours, to be adjusted accordingly, for example by adaptive fusion, for thereby providing improved driver assistance systems in cars and other vehicles.

Accordingly, there remains a need for improved systems for identifying the environment a vehicle is in.

### SUMMARY

According to a first aspect, there is provided a scene classification method for a vehicle sensor system, the method including the steps of: receiving feature maps generated from sensor data provided by the vehicle sensor system; processing the feature maps using longitudinal and lateral feature pooling to generate longitudinal and lateral feature pool outputs; generating inner products from the longitudinal and lateral feature pool outputs; and classifying the scene based on the generated inner products.

In this way, a computationally efficient classification method may be provided, which is able to outperform conventional classification architectures in terms of precision and recall performance. That is, by feature pooling the rows and columns of the feature maps, a low dimensional output may be generated, providing for efficient processing. At the same time the longitudinal and lateral pooling architecture leverages an awareness of scene features associated with particular environments to provide a high specificity for scene classification.

In embodiments, the step of generating the inner product includes concatenating the longitudinal and lateral feature pool outputs. In this way, the longitudinal and lateral feature pool outputs for each channel output by the convolutional layers may be linked for subsequent inner product processing.

In embodiments, the longitudinal and lateral feature pooling includes one of maximum or mean feature pooling. In this way, the size of the feature map may be reduced prior to subsequent inner product calculations.

In embodiments, the step of classifying the scene includes generating one or more scene classification scores using the generated inner products. In this way, scenes detected by the sensor system may be classified into one or more different scene categories. These results may then be used to provide scene category information for optimising other processes and systems within the vehicle.

In embodiments, the one or more scene classification scores provide a probability value indicating the probability that the associated scene is detected. In this way, the parameters used during the implementation of other processes and systems within the vehicle may be adjusted based on the probability results.

In embodiments, the vehicle sensor system is a RADAR or LIDAR system. In this way, scene classification data may be derived using only RADAR or LIDAR sensor systems.

In embodiments, the feature maps represent vehicle-centric coordinate system, and the direction of the rows and columns of the feature maps are parallel with the respective longitudinal and lateral axes of the coordinate system. In this way, awareness of the driving direction is leveraged to produce highly specific longitudinal and lateral feature pool outputs.

In embodiments, the classification method further includes the step of generating feature maps from the sensor data provided by the vehicle sensor system, wherein the step of generating the feature maps includes processing the sensor data through an object detection system. In this way, the classification method may be implemented as a head on an intermediate sematic representation for the object detection system, thereby capitalising on existing processing operations whilst providing additional classification functionality.

In embodiments, the object detection system includes an artificial neural network architecture. In this way, the classification head may be added to provide additional functionality to an existing trained model.

In embodiments, the artificial neural network architecture is a Radar Deep Object Recognition network, RaDOR.net.

According to a further aspect, there is provided a computer program product including instructions which, when the program is executed by a computer, cause the computer to carry out the steps of the above method.

According to a further aspect, there is provided a non-transitory computer readable medium including instructions, which when executed by a processor, cause the processor to execute the above method.

According to a further aspect, there is provided a scene classification apparatus for processing data from a vehicle sensor system, the apparatus including: an input for receiving feature maps generated from sensor data provided by the vehicle sensor system; and an encoding and pooling module for processing the feature maps using longitudinal and lateral feature pooling to generate longitudinal and lateral feature pool outputs; an inner product module for generating inner products from the longitudinal and lateral feature pool outputs; and a classifier for classifying the scene based on the generated inner products. In this way, an apparatus may be provided for implementing the above method.

In embodiments, the inner product module is configured to concatenate the longitudinal and lateral feature pool outputs.

In embodiments, the encoding and pooling module is configured to perform one of maximum or mean feature pooling.

In embodiments, the classifier is configured to generate one or more scene classification scores using the generated inner products.

In embodiments, the one or more scene classification scores provide a probability value indicating the probability that the associated scene is detected.

In embodiments, the vehicle sensor system is a RADAR or LIDAR system.

In embodiments, the feature maps represent a vehicle-centric coordinate system, and the direction of the rows and columns of the feature maps are parallel with the respective longitudinal and lateral axes of the coordinate system.

In embodiments, the scene classification apparatus further includes an object detection system for processing sensor data received from the vehicle sensor system to generate the feature maps.

In embodiments, the object detection system includes an artificial neural network architecture.

In embodiments, the artificial neural network architecture is a Radar Deep Object Recognition network, RaDOR.net.

### BRIEF DESCRIPTION OF DRAWINGS

Illustrative embodiments will now be described with reference to the accompanying drawings in which:

FIG. 1 shows a schematic illustration of a scene classification system based on an object detection architecture according to an embodiment;

FIG. 2 shows a schematic illustration of the scene classification head according to an embodiment;

FIG. 3 is a flow diagram of the processing steps employed in the scene classification system shown in FIG. 2; and

FIG. 4 is a graph comparing the scene classification performance of the illustrative embodiment with a conventional convolutional neural network and max pooling scene classification system.

### DETAILED DESCRIPTION

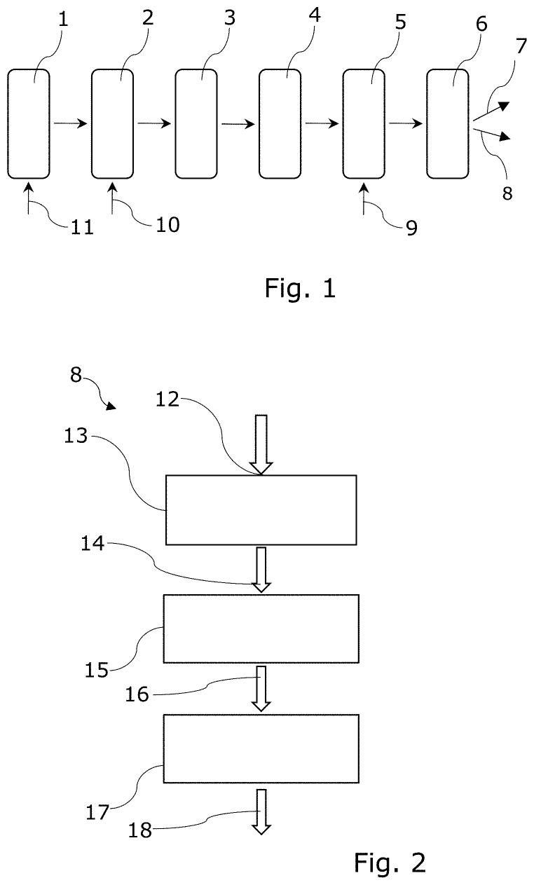

The scene classification system shown in FIG. 1 is based on an object detection architecture used to provide object detection and scene classification using radar-only data for an ego vehicle, namely the vehicle within which the radar system is incorporated. As such, the system is able to categorically classify the environment the subject vehicle is in based on the input radar data.

In this embodiment, the object detection architecture is object detection and semantic segmentation system employing a RaDOR-Net (Radar Deep Object Recognition network) architecture. RaDOR-Net is a deep-learning, end-to-end architecture for processing raw CDC (Compressed Data Cube) radar signals to provide semantic object and scene information, such as bounding boxes, free-space and semantic segmentation. The raw radar sensor data 11 from the vehicle's radar sensor system is input and processed through a number of processing layers. In this example, the processing layers include the CDC Domain SubNet 1, a POLAR Domain SubNet 2, a vehicle coordinate system (VCS) Sensor Domain 3, a VCS Fused Domain SubNet 4, a Gated Recurrent Unit (GRU) 5, and a dilated pyramid convolution layer 6. Looktype (scan type), Ego-motion, and Extrinsic Calibration data 11 may be fed into the Polar Domain SubNet 11, and Ego-motion data 10 may be fed into the GRU 5. The output from the Dilated Pyramid 6 is fed to a box head 7. At the same time, the output is fed to the scene classification head 8 for classification operations, as described in further detail below.

The scene classification head 8 is connected after the dilated pyramid convolution layer 6, and is used as a feature extractor. The input information accesses the full activation after the GRU 5 and processes this information in a cascade of layers into the final scene classification scores. In this respect, it will be understood that multiple classifications can be correct at the same time. For example, a rainy scene and approaching a tunnel scene may both be present. As such, the final class activation is transformed using a sigmoid activation function, together with a cross-entropy loss operation for optimization. Sigmoid activation is used to create probabilities for each output. Accordingly, the output scene classification scores provide an indication for each scene category of the probability that a scene is being detected.

With the arrangement described, by branching the scene classification head 8 after the dilated pyramid layer 6, several advantages may be achieved. Firstly, computational complexity is minimized because most calculations performed in the network for bounding box classification are also used for the scene classification head 8. This thereby significantly reduces the complexity at inference and training time compared to an architecture with earlier branching.

Secondly, it allows the scene classification head 8 to be incorporated into existing neural networks. That is, because the branch from the network occurs at the end, the calculations applied to the original output of an existing network remain unchanged. Accordingly, trained existing networks can be used, and their capabilities can simply be extended by the scene classification output, without affecting with the original performance.

Thirdly, data utilization is also improved. The scene classification head works with highly semantic features, already trained on a large dataset. Consequently, less parameters are required for the new scene classification output. This not only reduces computational complexity, but also reduces the number of samples which are required for the model to generalize well.

An illustrative scene classification head 8 is shown in FIG. 2. The output from the dilated pyramid convolution layer 6 is fed to the input 12. An encoding and pooling module 13 processes the input data, firstly by using 2D-convolutions to encode local features. The aggregated feature data, is then processed using a longitudinal and lateral feature pooling technique, as is discussed in further detail below. The feature pooling output 14 is then fed to an inner product module 15 to produce a low dimensional, inner product output 16. As such, a final feature vector is generated for scene classification. Accordingly, the inner product output 16 is then fed to a classifier module 17 which classifies the scene and outputs one or more scene classification scores 18.

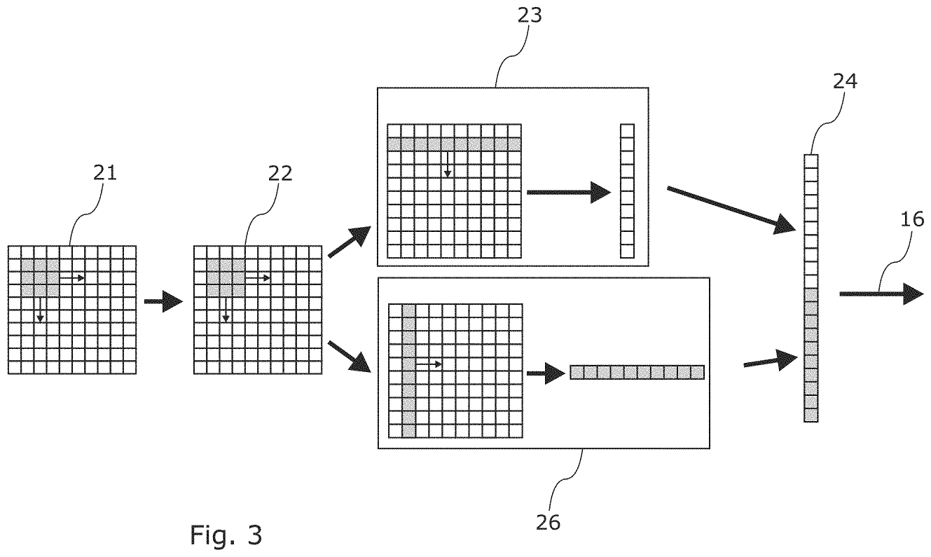

To explain the scene classification method in further detail, FIG. 3 shows a flow diagram of the processing steps employed in the scene classification architecture. As mentioned above, the scene classification head 8 utilizes stacked lateral and longitudinal feature pooling, concatenation, and inner product calculations. For simplicity, only a single channel of the multi-channel activations is shown in FIG. 3.

As will be understood, the raw CDC radar data is processed through a plurality of convolutional layers within the object detection architecture shown in FIG. 1. In FIG. 3, for simplicity, these are represented by convolutional layers 21 and 22. The output of the object detection architecture produces feature or activation maps in which aggregated features result in highly activated areas within the channel matrices.

As will be understood, the feature maps output by the convolutional layers 21 and 22 follow a vehicle-centric coordinate system. This coordinate system defines the longitudinal and lateral axes along the column and row directions of the feature maps. The ego vehicle's driving direction is along the x axis of this coordinate system.

The feature maps are subjected to longitudinal feature pooling 23 and lateral feature pooling 26 within the encoding and pooling module 13. These pooling operations are used to reduce the dimensions of the feature maps by summarising the features present in the longitudinal columns and lateral rows of the feature maps generated by the convolution layers 21,22. Maximum or mean feature pooling may be used. In maximum feature pooling, the maximum element is taken from each column or row of the feature map. As such, the output after maximum pooling is a feature map containing the most prominent features of each column or row of the previous feature map. In mean feature pooling, the mean average of the elements present in each column or row of the feature map is taken. As such, the output after mean-pooling is a feature map containing the average features for each column or row of the previous feature map.

The lateral and longitudinal feature pooling results are then concatenated and an inner product calculation 24 is produced.

In a scenario where the car approaches a tunnel, the lateral feature pooling 26 will result in stable features during the approach. In contrast, the longitudinal feature pooling 23 will be distance dependent. For instance, if a tunnel is a distance away (e.g. 80 m), the features of the tunnel will propagate along the vector as the car approaches. As such, it is possible to efficiently encode distance to scene transitions, for example, approaching tunnel in 40 m. Accordingly, scenes of different types will result in different combination of the lateral and longitudinal feature pooling results. By concatenating these, and calculating their inner products, one or more scene classification scores can thereby be produced to provide a probability value indicating the probability that vehicle is in the associated scene category. A probability threshold may be set by which scene classification scores above a specified level are used to confirm the identification of a particular scene.

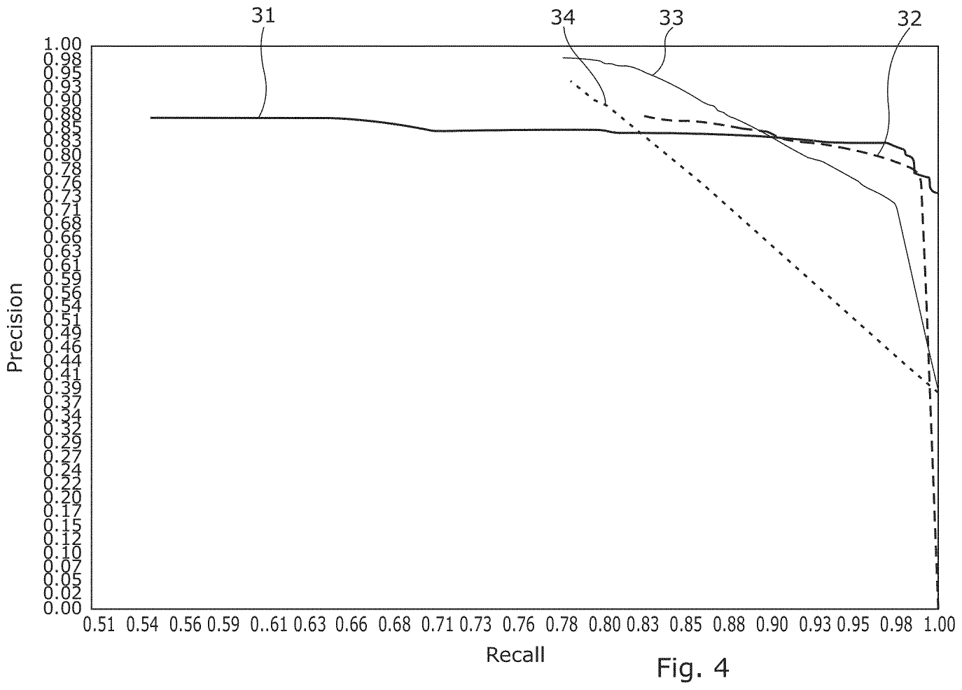

FIG. 4 is a graph comparing the scene classification performance of the illustrative embodiment with a conventional convolutional neural network and max pooling scene classification system. The recall-precision performance when the ego vehicle is in a parking garage scene is identified by line 31 for the illustrative embodiment, and contrasted with line 32 associated with a conventional classification system. Equally, the recall-precision performance when the ego vehicle is in a tunnel scene is identified by line 33 for the illustrative embodiment, and contrasted with line 34 associated with a conventional classification system. As shown, in both cases, higher recall and precision values are achieved with the illustrative embodiment.

Accordingly, the above methods and systems allow for highly accurate and computationally efficient scene classification.

It will be understood that the embodiments illustrated above show applications only for the purposes of illustration. In practice, embodiments may be applied to many different configurations, the detailed embodiments being straightforward for those skilled in the art to implement.

For example, although in the above illustrative examples, the scene classification head is implemented using a plurality of modules, it will be understood that this, as well as the object detection architecture generally may be implemented using one or more microprocessors, for instance as part of an embedded device or an automotive controller unit.

It will be appreciated that a vehicle advanced driver assist system can operate the scene classification method as described above and adapt one of more functions of the system according to the classification from the method. In particular, as a non-exclusive list, the system can use the classification from the method for blind spot, information, lane departure warning, braking, speed adjustment, parking and so on.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

1-23. (canceled)

24. A method comprising:
receiving feature maps generated from sensor data provided by a sensor system;
processing the feature maps using longitudinal and lateral feature pooling to generate longitudinal and lateral feature pool outputs;
generating inner products from the longitudinal and lateral feature pool outputs; and
classifying a scene based on the generated inner products.

25. The method of claim 24, wherein generating the inner product further comprises:
concatenating the longitudinal and lateral feature pool outputs.

26. The method of claim 24, wherein the longitudinal and lateral feature pooling comprises at least one of:
maximum feature pooling; or
mean feature pooling.

27. The method of claim 24, wherein classifying the scene further comprises:
generating one or more scene classification scores using the generated inner products.

28. The method of claim 27, wherein the one or more scene classification scores provide a probability value indicating the probability that an associated scene is detected.

29. The method of claim 24, wherein the sensor system is at least one of a radio detection and ranging (RADAR) or a light detection and ranging (LIDAR) system.

30. The method of claim 29,
wherein the feature maps represent a vehicle-centric coordinate system, and
wherein a direction of rows and columns of the feature maps are parallel with respective longitudinal and lateral axes of the vehicle-centric coordinate system.

31. The method of claim 24, further comprising:
generating feature maps from the sensor data provided by the sensor system,
wherein generating the feature maps comprises processing the sensor data through an object detection system.

32. The method of claim 31, wherein the object detection system comprises an artificial neural network architecture.

33. The method of claim 32, wherein the artificial neural network architecture is a Radar Deep Object Recognition network.

34. A system comprising:
one or more processors; and
a non-transitory computer-readable medium coupled to the one or more processors, the non-transitory computer-readable medium storing instructions that, when executed by the one or more processors, cause the one or more processors to:
receive, via an input, feature maps generated from sensor data provided by a sensor system;
process, using an encoding and pooling module, the feature maps using longitudinal and lateral feature pooling to generate longitudinal and lateral feature pool outputs;
generate, using an inner product module, inner products from the longitudinal and lateral feature pool outputs; and
classify, using a classifier, a scene based on the generated inner products.

35. The system of claim 34, wherein the instructions further cause the one or more processors to:
concatenate, via the inner product module, the longitudinal and lateral feature pool outputs.

36. The system of claim 34, wherein the instructions further cause the one or more processors to:
perform, via the encoding and pooling module, at least one of a maximum feature pooling or a mean feature pooling.

37. The system of claim 34, wherein the instructions further cause the one or more processors to:
generate, via the classifier, one or more scene classification scores using the generated inner products.

38. The system of claim 37, wherein the one or more scene classification scores provide a probability value indicating the probability that an associated scene is detected.

39. The system of claim 34, wherein the sensor system is at least one of a RADAR or a LIDAR system.

40. The system of claim 34,
wherein the feature maps represent a vehicle-centric coordinate system, and
wherein a direction of rows and columns of the feature maps are parallel with respective longitudinal and lateral axes of the vehicle-centric coordinate system.

41. The system of claim 34, further comprising:
an object detection system for processing sensor data received from the sensor system to generate the feature maps.

42. The system of claim 41, wherein the object detection system further comprises an artificial neural network architecture.

43. The system of claim 42, wherein the artificial neural network architecture comprises a Radar Deep Object Recognition network.
